(19) United States
(12) Patent Application Publication
(10) Pub. No.: US 2011/0262651 A1
(43) Pub. Date: Oct. 27, 2011

(54) METHOD OF MANUFACTURING POLYMER OPTICAL WAVEGUIDE

(75) Inventor: Mutsumi Ogawa, Yokohama-shi (JP)

(73) Assignee: NITTO DENKO CORPORATION, Osaka (JP)

(21) Appl. No.: 13/088,529

(22) Filed: Apr. 18, 2011

(30) Foreign Application Priority Data
Apr. 26, 2010 (JP) 2010-100804

(51) Int. Cl. G02B 6/132

(52) U.S. Cl. 427/487

(57) ABSTRACT

A method of manufacturing a polymer optical waveguide which is capable of efficiently manufacturing a polymer optical waveguide with a low optical loss by using a photosensitive resin of the type hardenable by a photo-cationic polymerization reaction is provided. The polymer optical waveguide includes light-transmitting cores, an under cladding layer provided under the cores, and an over cladding layer provided to cover the cores. The method includes applying a core-forming photo-cationic polymerizable resin composition containing a solvent to the surface of the under cladding layer volatilizing the solvent in a layer of the core-forming resin composition (2′) by a heating treatment; adjusting a residual solvent concentration in the core-forming resin composition after the heating step to 1 wt % or less.

### BACKGROUND OF THE INVENTION

1. Field of the Invention

The present invention relates to a method of manufacturing a polymer optical waveguide.

2. Description of the Related Art

In recent years, with the increasing fields of optical communications, optical information processing and other general optics, there has been an increasing demand for optical waveguides for optical connection of a plurality of optical devices. An example of the optical waveguides of this type generally used includes a polymer optical waveguide that has cores (a core layer) made of a polymer material, an over cladding layer made of a polymer material and provided over the cores, and an under cladding layer made of the same material as the over cladding layer and provided under the cores.

In general, the cores of the above-mentioned polymer optical waveguide are formed in a pattern extending in the longitudinal direction of the optical waveguide (or along the optical path), and each have a substantially rectangular cross-sectional configuration. The cores having such a pattern are formed by a photolithographic method using a photosensitive resin such as an ultraviolet curable resin, as disclosed in Japanese Published Patent Applications Nos. 2007-279237 and 2008-275999. Specifically, the under cladding layer is formed on a substrate, and thereafter a photosensitive resin composition layer for the formation of the cores is formed on the under cladding layer. The photosensitive resin composition layer is exposed to irradiation light through a photomask. Development is performed using a developing solution to remove unexposed portions of the photosensitive resin composition layer. This provides the cores having the above-mentioned predetermined pattern.

Examples of the base compound of the photo sensitive resin composition for the formation of the cores for use herein include photosensitive resins of the type hardenable by a photo-cationic polymerization reaction (also referred to hereinafter as photo-cationic polymerizable resins), such as epoxy-based resins, oxetane-based resins and vinyl ether-based resins, which are excellent in the dimensional accuracy of formed products. The resin composition is provided by adding a photocatalyst such as a photo-acid generator, a solvent for viscosity adjustment, and aids such as a reactive oligomer, a diluent, and a coupling agent to the photo-cationic polymerizable resins.

When the cores are formed in the polymer optical waveguide by a photolithographic method using the photo-cationic polymerizable resin, the width of the produced cores (the whole width of the cores along the width of the optical waveguide) is greater than its design value in some cases. However, when the width of the cores thus obtained is greater than its design value, there is apprehension that the total loss of light increases, so that the polymer optical waveguide fails to deliver proper performance as originally designed. The amelioration thereof is hence desired.

A method of manufacturing a polymer optical waveguide is provided which is capable of efficiently manufacturing a polymer optical waveguide with a low optical loss by using a photosensitive resin of the type hardenable by a photo-cationic polymerization reaction.

The polymer optical waveguide includes light-transmitting cores, an under cladding layer provided under the cores, and an over cladding layer provided to cover the cores, at least the cores being formed using a photosensitive resin of the type hardenable by a photo-cationic polymerization reaction. The method comprises the steps of: applying a core-forming resin composition containing the photosensitive resin of the type hardenable by the photo-cationic polymerization reaction and a solvent to the surface of the under cladding layer formed on a substrate; heating the core-forming resin composition to volatilize the solvent in the core-forming resin composition; controlling heating conditions in the heating step to adjust a residual solvent concentration in the core-forming resin composition to 1 wt % or less; and directing irradiation light through a photomask toward a layer of the core-forming resin composition after the heating step to expose the layer of the core-forming resin composition to the irradiation light, and then developing the layer of the core-forming resin composition to form the cores of a predetermined pattern.

### SUMMARY OF THE INVENTION

The present inventor has made a series of studies to diagnose the cause of the occurrence of a situation in which the whole width of the cores becomes greater than its design value when the photosensitive resin of the type hardenable by the photo-cationic polymerization reaction is used as the material for the formation of the cores. In the course of the studies, the present inventor has assumed that the above-mentioned greater width of the cores is caused by the diffusion of active species (hydrogen ions) created by irradiation with light to a region not exposed to the light because of the presence of the mask (a region adjacent to the cores and not designed), and has made further studies. As a result, the present inventor has found that the diffusion of the active species results from the solvent blended in the material for the formation of the cores. Specifically, the present inventor has found that the active species are mobile in the photo-cationic polymerizable resin composition because the material for the formation of the cores (the photo-cationic polymerizable resin composition) is in the form of varnish that is less viscous than the solvent. Based on this finding, the present inventor has found that, if the photo-cationic polymerizable resin is used, optical waveguide cores with high dimensional accuracy is provided by decreasing the amount of solvent in the material for the formation of cores to a proper concentration range prior to exposure to light so as to suppress the movement of the active species.

As described above, the method of manufacturing a polymer optical waveguide by a photolithographic method using a photo-cationic polymerizable resin includes the heating step for volatilizing the solvent in the core-forming resin composition, and the control step for controlling the heating conditions in the heating step to adjust the residual solvent concentration in the core-forming resin composition to 1 wt % or less, prior to the exposure of the cores to light. This allows the residual solvent concentration (in wt % which is calculated by dividing the mass of the residual solvent by the mass of the whole resin composition) in the core-forming resin composition after the exposure to light to be decreased to a proper concentration range, thereby preventing the increase in the core width resulting from the above-mentioned movement of the active species. As a result, the core width is not increased during the formation of the cores (i.e., during the heating treatment after the exposure to light), but the cores are formed with accuracy to have a width as originally designed. This reduces the total loss in the cores to achieve the manufacture of a high-performance polymer optical waveguide made of a photo-cationic polymerizable resin.

### BRIEF DESCRIPTION OF THE DRAWINGS

FIGS. 1A to 1C are schematic views illustrating a process for forming an under cladding layer in a method of manufacturing a polymer optical waveguide according to an embodiment of the present invention.

FIGS. 2A to 2F are schematic views illustrating a process for forming cores in the method of manufacturing a polymer optical waveguide according to the embodiment of the present invention.

FIGS. 3A to 3C are schematic views illustrating a process for forming an over cladding layer in the method of manufacturing a polymer optical waveguide according to the embodiment of the present invention.

FIG. 3D is a schematic end view of a polymer optical waveguide provided by the manufacturing method.

FIG. 4 is a graph showing a relationship between a residual solvent concentration in a core-forming material layer prior to irradiation with ultraviolet light and the width of the produced cores.

FIG. 5 is a graph showing a relationship between a residual solvent concentration in a core-forming material layer prior to irradiation with ultraviolet light and the total loss in the produced cores.

FIG. 6A is a schematic view showing light being guided through cores in a polymer optical waveguide in Inventive Example.

FIG. 6B is a schematic view showing light being guided through cores in a polymer optical waveguide in Comparative Example 1.

### DETAILED DESCRIPTION OF THE INVENTION

An embodiment will be described in detail with reference to the drawings.

A brief description will be given on a method of manufacturing a polymer optical waveguide according to the present embodiment.

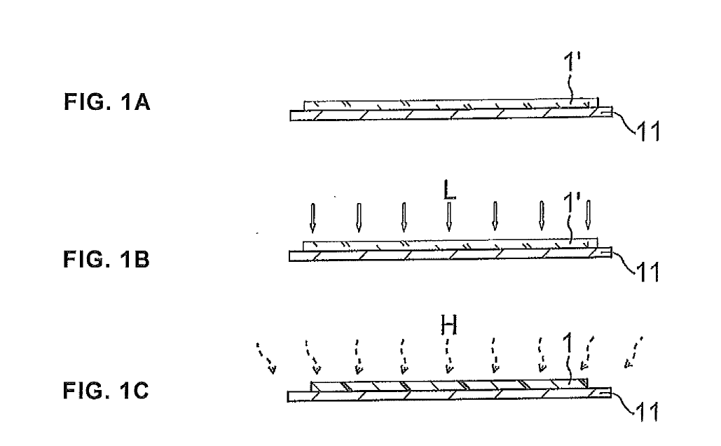

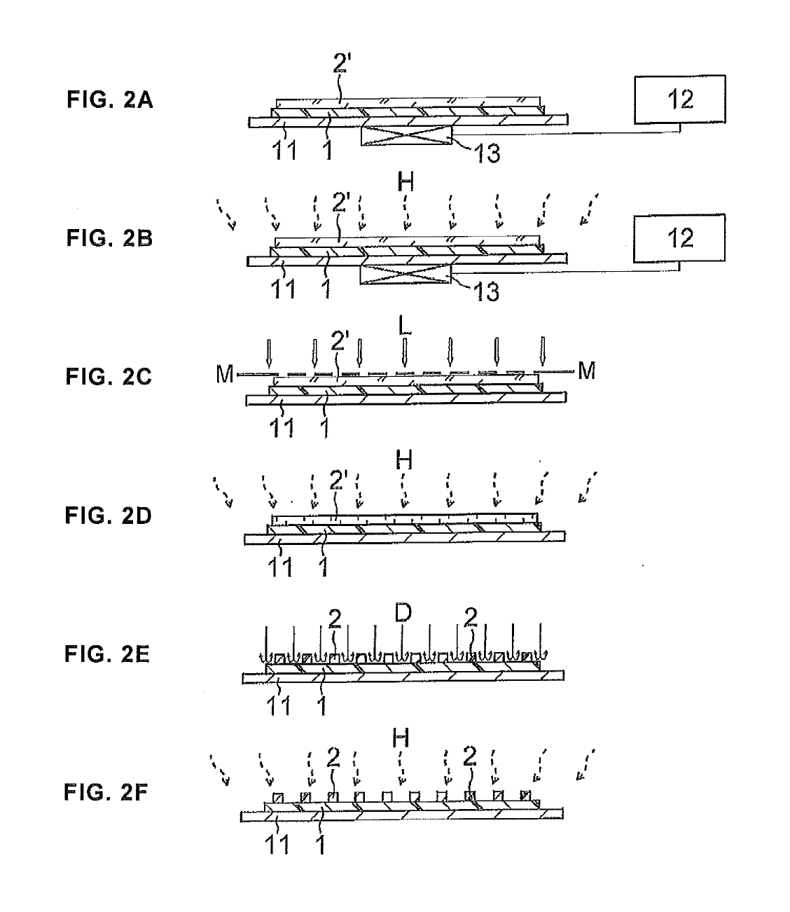

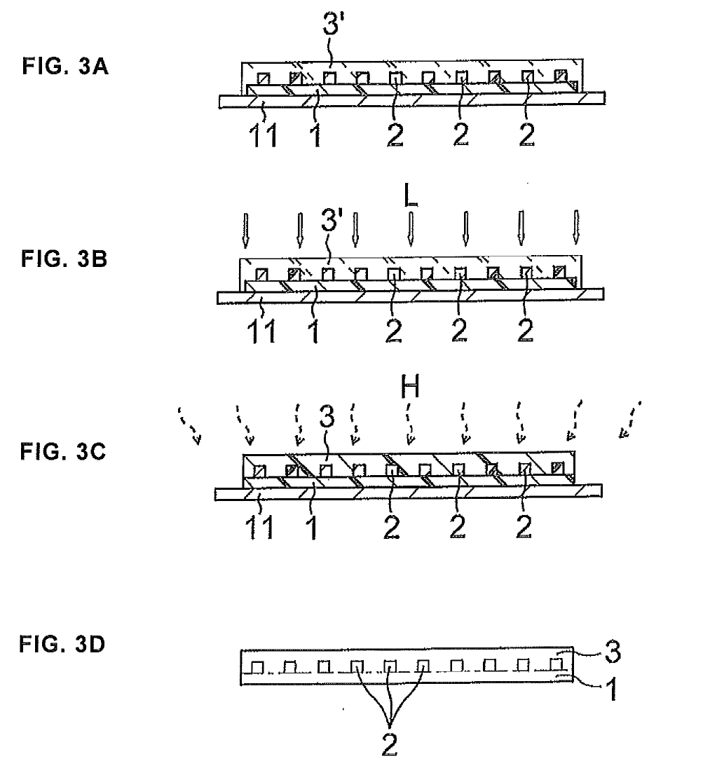

In this manufacturing method, a substrate 11 such as a silicon wafer and a glass substrate is prepared, and an under cladding layer 1 is formed on the substrate 11, as shown in FIGS. 1A to 1C. Then, as shown in FIGS. 2A to 2F, a core-forming resin composition (also referred to as a “varnish”) including a photosensitive resin (a photo-cationic polymerizable resin) as mentioned earlier and a solvent is used to form a resin layer (2′) on the under cladding layer 1. This resin layer is exposed to light through a photomask M having a predetermined pattern, and is then developed. The patterned resin layer is formed into cores 2 by hardening. Then, as shown in FIGS. 3A to 3C, an over cladding layer 3 is formed so as to cover the cores 2 formed on the under cladding layer 1. In this manner, a polymer optical waveguide as shown in FIG. 3D is provided. In the course of the production of the cores 2, as shown in FIG. 2B, a heating step for volatilizing the solvent in the core-forming resin composition (the resin layer) by heating to decrease a residual solvent concentration in the resin layer to 1 wt % or less is performed before the resin layer is exposed to light, thereby preventing the width of the resultant cores from being greater than its design value.

Next, the manufacturing method will be described in detail. First, the substrate 11 of a flat shape is prepared. Examples of the substrate 11 used herein include a silicon wafer and a glass substrate as mentioned earlier. In addition, substrates made of resin, metal and the like may be used as the substrate 11. Then, as shown in FIG. 1A, a resin composition 1′ for the formation of the under cladding layer 1 is applied to a predetermined region of the surface of the substrate 11. The application of the resin composition 1′ is achieved, for example, by a spin coating method. Then, the resin composition 1′ is hardened to produce the under cladding layer 1.

The hardening of the under cladding layer 1 is done as appropriate depending on the material for the formation of the under cladding layer 1, the thickness of the under cladding layer 1, and the like. As an example, when a photosensitive resin is used as the material for the formation of the under cladding layer 1, the layer of the resin composition 1′ is irradiated with ultraviolet light (as indicated by hollow arrows L), as shown in FIG. 1B, and thereafter a heating treatment (as indicated by broken arrows H) using an oven and the like is performed, as shown in FIG. 1C. Thus, the hardening of the under cladding layer 1 is completed.

Then, as shown in FIG. 2A, a photo-cationic polymerizable resin composition (varnish 2′) for the formation of the cores 2 is applied onto the under cladding layer 1. As shown in FIG. 2B, a heating treatment H is performed to volatilize the solvent in the varnish 2′. The layer of the varnish 2′ of a decreased residual solvent concentration is irradiated with ultraviolet light L through the photomask M, as shown in FIG. 2C. Thereafter, as shown in FIG. 2D, a heating treatment H is performed to complete the hardening of the layer of the varnish 2′. Thereafter, as shown in FIG. 2E, development using a developing solution D is performed by an immersion method, a spray method, a puddle method and the like to dissolve away unexposed portions of the photo-cationic polymerizable resin layer (2′), thereby forming the remaining photo-cationic polymerizable resin layer into the pattern of the cores 2. Then, as shown in FIG. 2F, a heating treatment H is performed to dry the resultant portions to be formed as the cores 2, thereby providing the cores 2 of a substantially rectangular sectional configuration.

This process will be described in further detail. First, the varnish 2′ including the photosensitive photo-cationic polymerizable resin and the solvent is applied onto the under cladding layer 1 by a spin coating method and the like. In this step, as shown in FIG. 2A, the mass of the layer of the varnish 2′ (together with the substrate 11 and the under cladding layer 1) immediately after the application is measured with amass meter 13 and the like, and is stored in a control means 12 using a computer (in a control step). The amount (concentration) of the solvent in the varnish 2′ prior to the application (in the initial step) is 20 to 40 wt %.

Next, as shown in FIG. 2B, the layer of the varnish 2′ together with the substrate 11 is heated. This volatilizes part of the solvent in the varnish 2′ to decrease the amount of solvent remaining in the varnish 2′ to a predetermined concentration range (1 wt % or less). The control means 12 determines heating conditions in this process by monitoring a change in the mass of the layer of the varnish 2′ during the heating with the mass meter 13 and the like. A change in the concentration of the solvent in the varnish 2′ is determined by making a comparison between the mass stored in the control means 12 prior to the heating and the mass after the heating (the mass of the substrate 11 and the under cladding layer 1 is canceled out). The decrease in the amount of the residual solvent in the varnish 2′ to the predetermined concentration or less is verified similarly in real time by the mass measurement with the mass meter 13 and the like (in the control step).

The term “control step” used herein encompasses a series of operations, means and devices for measuring and recording the amount (concentration) of the solvent in the varnish 2′ to control the heating conditions in the heating step based on the recorded amount, thereby adjusting the residual solvent concentration in the varnish 2′ after the heating to 1 wt % or less.

If it is difficult to provide the mass meter 13 and the like as an in-line device for the heating step, the heating conditions in the step may be previously established by a preliminary experiment and the like, so that the control means 12 controls temperature, humidity, the volume of air, heating time and the like for a heating device for the step. For the measurement of the concentration of the solvent remaining in the varnish 2′, other methods may be used which include a method of measuring the solvent concentration in a non-contacting manner by an optical technique using reflectance, absorptance and the like, and a method of measuring the solvent concentration in an exhaust gas emitted from an oven and the like to estimate the amount of volatilized solvent.

After the residual solvent concentration in the varnish 2′ is decreased by the above-mentioned heating, ultraviolet light L is directed toward the layer of the varnish 2′ through the photomask M having an opening corresponding to the core pattern to expose the layer of the varnish 2′ in a predetermined pattern to the ultraviolet light L, as shown in FIG. 2C. For the irradiation with the ultraviolet light L through the photomask M, an ultra-high-pressure mercury-vapor lamp, a high-pressure mercury-vapor lamp, and the like are typically used. From the viewpoint of resolution of the core pattern, an exposure filter known as a band-pass filter is used so as to perform irradiation with only an intended exposure line, depending on the type of photosensitive material.

After the completion of the exposure with the ultraviolet light L, the heating treatment H is performed to complete the photoreaction, as shown in FIG. 2D. Since the residual solvent concentration in the varnish 2′ for the formation of the cores 2 is decreased to 1 wt % or less by the heating step (with reference to FIG. 2B) prior to the exposure step in the method of manufacturing a polymer optical waveguide according to the present embodiment, the movement of active species created by the irradiation with the ultraviolet light L in the varnish 2′ is suppressed during the heating treatment H after the exposure step.

After the completion of the hardening, development is performed using the developing solution D by an immersion method and the like, as shown in FIG. 2E, to dissolve away unexposed portions of the layer of the varnish 2′, thereby forming the remaining layer of the photo-cationic polymerizable resin into the pattern of the cores 2. Then, as shown in FIG. 2F, the developing solution D in the remaining resin layer formed in the pattern of the cores 2 is removed by the heating treatment H. This provides the pattern of the cores 2 of a predetermined configuration formed on the under cladding layer 1.

Next, as shown in FIG. 3A, a resin composition 3′ for the formation of the over cladding layer 3 for covering the under cladding layer 1 and the cores 2 is applied in a manner similar to that for the under cladding layer 1. Then, the resin composition 3′ is hardened to produce the over cladding layer 3.

When a photosensitive resin is used as the material for the formation of the over cladding layer 3, the layer of the resin composition 3′ is irradiated with ultraviolet light L, as shown in FIG. 3B, and thereafter a heating treatment H is performed, as shown in FIG. 3C, to complete the hardening of the over cladding layer 3. When a thermosetting resin is used as the material for the formation of the over cladding layer 3, only the process of hardening the over cladding layer 3 by the heating treatment H shown in FIG. 3C is performed.

Then, dicing (not shown) using cutting edges is performed to cut off a longitudinal end portion of the polymer optical waveguide, thereby providing a desired length of the polymer optical waveguide. This provides the polymer optical waveguide in which longitudinal end surfaces (square end surfaces) of the respective cores 2 are uncovered at a longitudinal end surface of the polymer optical waveguide, as shown in FIG. 3D.

As mentioned above, the method of manufacturing a polymer optical waveguide according to the present embodiment includes the heating step (with reference to FIG. 2B) for volatilizing the solvent in the resin composition (varnish 2′) for the formation of the cores 2, and the control step (the control means 12 and the like) for adjusting the residual solvent concentration in the varnish 2′ to 1 wt % or less, before the step of exposure of the cores 2 to the ultraviolet light L. Thus, when the photo-cationic polymerizable resin is used, the width of the cores 2 when formed is not too wide, but the cores 2 are formed with accuracy so as to have a proper width as designed. Additionally, the precise width of the cores 2 reduces the total loss of the cores 2 to consequently achieve the manufacture of high-performance high-quality polymer optical waveguides with a high yield.

In the above-mentioned embodiment, the cores 2 are shown only in cross-section. However, the method of manufacturing a polymer optical waveguide is applicable not only to an optical waveguide including a straight core pattern extending in the longitudinal direction but also to an optical waveguide including a curved core pattern, an optical waveguide including cores branching off for demultiplexing and multiplexing optical signals, an optical waveguide including cores intersecting each other for the recombination of optical signals, and the like.

The materials for the formation of the under cladding layer, the over cladding layer and the cores for use in the method of manufacturing a polymer optical waveguide include resins of the type having an epoxy group and a vinyl ether group and hardenable by a photo-cationic polymerization reaction, such as epoxy-based resins, oxetane-based resins and vinyl ether-based resins. Examples of such resins include photosensitive resins (photopolymerizable resins) such as epoxy resins, polyimide resins, and polysilicone resins. Of these resins, cationic polymerizable epoxy resins are preferable from the viewpoints of costs, film thickness controllability, losses and the like. However, a difference in refractive index between the under and over cladding layers and the cores is caused by changing the type and amount of additives. The proportion of the photo-cationic polymerizable resin to the whole core-forming resin composition (the whole varnish) is generally 40 to 100 wt %, preferably 50 to 80 wt %.

The above-mentioned photo-cationic polymerizable resin together with a photocatalyst such as a photo-acid generator constitutes a photo-cationic polymerizable resin composition. The photo-cationic polymerizable resin composition may contain other components including a reactive oligomer, a diluent, a coupling agent, and the like.

Examples of the photo-acid generator include compounds of onium salts and metallocene complexes. Examples of the onium salts include diazonium salts, sulfonium salts, iodonium salts, phosphonium salts, and selenium salts. Examples of counterions of these salts include anions such as CF₃SO₃⁻, BF₄⁻, PF₆⁻, AsF₆⁻, and SbF₆⁻. Specific examples include triphenylsulfonium triflate, 4-chlorobenzene diazonium hexafluorophosphate, triphenylsulfonium hexafluoroantimonate, triphenylsulfonium hexafluorophosphate, (4-phenylthio-phenyl)diphenyl sulfonium hexafluoroantimonate, (4-phenylthio-phenyl)diphenyl sulfonium hexafluorophosphate, bis[4-(diphenyl sulfonio)phenyl]sulfide-bis-hexafluoroantimonate, bis[4-(diphenyl sulfonio)phenyl]sulfide-bis-hexafluorophosphate, (4-methoxyphenyl)diphenyl sulfonium hexafluoroantimonate, (4-methoxyphenyl)phenyl iodonium hexafluoroantimonate, bis(4-t-butylphenyl)iodonium hexafluorophosphate, benzyltriphenylphosphonium hexafluoroantimonate, and triphenylselenium hexafluorophosphate. These compounds are used either singly or in combination. The proportion of the photo-acid generator to the whole core-forming resin composition (the whole varnish) is generally 0.01 to 10 wt %, preferably 0.1 to 5 wt %.

Examples of the reactive oligomer include fluorene derivative type epoxies, many other epoxies, epoxy (meth)acrylates, urethane acrylates, butadiene acrylates, and oxetanes. In particular, oxetanes are preferable because of their effect of accelerating the hardening of polymerizable mixtures by the addition of only small amounts thereof. Examples of the oxetanes include 3-ethyl-3-hydroxymethyl oxetane, 3-ethyl-3-(phenoxymethyl)oxetane, di(1-ethyl(3-oxetanyl))methyl ether, and 3-ethyl-3-(2-ethylhexylmethyl)oxetane. These reactive oligomers are used either singly or in combination.

Examples of the diluent include alkyl monoglycidyl ethers with a carbon number in the range of 2 to 25, such as butyl glycidyl ether and 2-ethylhexyl glycidyl ether, butanediol diglycidyl ether, 1,6-hexanediol diglycidyl ether, neopentyl glycol diglycidyl ether, dodecanediol diglycidyl ether, penta-erythritol polyglycidyl ether, trimethylolpropane polyglycidyl ether, glycerol polyglycidyl ether, phenyl glycidyl ether, resorcinol glycidyl ether, p-tert-butylphenyl glycidyl ether, allyl glycidyl ether, tetrafluoropropyl glycidyl ether, octafluoropropyl glycidyl ether, dodecafluoropentyl glycidyl ether, styrene oxide, 1,7-octadiene diepoxide, limonene diepoxide, limonene monoxide, α-pinene epoxide, β-pinene epoxide, cyclohexene epoxide, cyclooctene epoxide, and vinylcyclohexene oxide.

Examples of the diluent preferable from the viewpoints of heat resistance and transparency include epoxies having an alicyclic structure in the molecules, such as 3,4-epoxycyclohexenylmethyl-3′,4′-epoxycyclohexene carboxylate, 3,4-epoxycyclohexenylethyl-8,4-epoxycyclohexene carboxylate, vinylcyclohexene dioxide, allylcyclohexene dioxide, 8,4-epoxy-4-methylcyclohexyl-2-propylene oxide, and bis(3,4-epoxycyclohexyl)ether. Mixing suitable amounts of these diluents with epoxy resins serving as a base compound increases the reaction rate of the epoxy groups to consequently improve the heat resistance of the resultant hardened material and the flexibility thereof as a film.

The coupling agent used herein includes epoxy-based coupling agents. Examples of the epoxy-based coupling agents include 2-(3,4-epoxycyclohexyl)ethyltrimethoxysilane, 3-glycidoxypropyltrimethoxysilane, 3-glycidoxypropyl methyldiethoxysilane, and 3-glycidoxypropyltriethoxysilane. Also, amino-based coupling agents may be used, such as 3-aminopropyltrimethoxysilane, and 3-aminopropyltriethoxysilane.

A viscosity-adjusting solvent (an organic solvent that does not react with the photo-cationic polymerizable resin serving as a base compound but has only the functions of swelling and plasticizing the resin) is added to the photo-cationic polymerizable resin composition serving as the material for the formation of the cores. Examples of the viscosity-adjusting solvent include ethyl lactate, cyclohexanone, and methyl ethyl ketone (MEK). The proportion of the viscosity-adjusting solvent to the whole core-forming resin composition (the whole varnish) is generally not greater than 50 wt %, preferably 20 to 40 wt %.

In consideration of the increase or decrease in size after the forming, it is preferable that the photosensitive resin composition serving as the material for the formation of the under and over cladding layers does not contain the viscosity-adjusting solvent. For example, when an epoxy resin is used, the use of an epoxy monomer in liquid form in place of the above-mentioned solvent makes the material for the formation of the over cladding layer solvent-free. Examples of the epoxy monomer in liquid form include Celloxide 2021P available from Daicel Chemical Industries, Ltd., Celloxide 2081 available from Daicel Chemical Industries, Ltd., and ADEKA RESIN EP-4080E available from ADEKA Corporation. Using these epoxy monomers in liquid form, the epoxy resins in solid form or in viscous liquid form are dissolved and made solvent-free.

Next, an inventive example will be described in conjunction with comparative examples. It should be noted that the present invention is not limited to the inventive example.

### EXAMPLES

Prior to Inventive Example, materials for use in Inventive Example were prepared. Materials for use in Comparative Examples were the same materials as in Inventive Example.

### Material for Formation of Under Cladding Layer and Over Cladding Layer

Component A: (liquid epoxy resin) 100 parts by weight of an epoxy resin having an alicyclic skeleton <ADEKA RESIN EP-4080E available from ADEKA Corporation>.

Component B: (photo-acid generator) one part by weight of a 50% propylene carbonate solution of a triaryl sulfonium salt <CPI-200K available from San-Apro Ltd.>.

### Material for Formation of Cores

Component C: (photo-cationic polymerizable epoxy resin) 100 parts by weight of O-cresol novolac glycidyl ether <YDCN-700-10 available from Tohto Kasei Co., Ltd.>.

Component B: (photo-acid generator) 0.5 part by weight of a 50% propione carbonate solution of a triaryl sulfonium salt <CPI-200K available from San-Apro Ltd.>.

A varnish serving as a material (a photopolymerizable resin composition) for the formation of cores was prepared by stirring (at a temperature of 80° C. at 250 rpm for three hours) to dissolve these components in 60 parts by weight of ethyl lactate <available from Musashino Chemical Laboratory, Ltd.> serving as a solvent. The amount (concentration) of the solvent contained in the prepared varnish was 37.3 wt % (blending value). The viscosity of the prepared varnish was 1800 mPa·s when measured with a digital viscometer <HBDV-I+CP available from Brookfield Engineering Laboratories, Inc.>.

Next, a polymer optical waveguide in Inventive Example was produced in a manner similar to that in the above-mentioned embodiment.

### Inventive Example

### Production of Under Cladding Layer

First, the material for the formation of the cladding layers was applied to the surface of a glass substrate <measuring 11 mm in thickness and 140 mm per side> with a spin coater <1X-DX2 available from Mikasa Co., Ltd.>. Thereafter, ultraviolet light (mixed irradiation) was directed toward the entire surface of the applied material to expose the entire surface to the ultraviolet light at a dose of 1000 mJ/cm <using an exposure machine (MA-60F available from Mikasa Co., Ltd.) and an ultra-high-pressure mercury-vapor lamp (USH-250D available from Ushio Inc.)>. Subsequently, a heating treatment for hardening was performed at 80° C. for five minutes to produce the under cladding layer on the substrate. A sectional dimension of the resultant under cladding layer was 25 μm in thickness when measured under a digital microscope <VHX-200 available from Keyence Corporation>.

### Production of Cores

Next, the material for the formation of the cores was applied to the surface of the under cladding layer with a spin coater <1X-DX2 available from Mikasa Co., Ltd.>. Then, the overall weight was measured with a mass meter. As shown in FIG. 2B, a heating treatment was performed at 100 to 160° C. for five to 30 minutes. Thereafter, the overall weight was measured again with the mass meter. The concentration of the solvent (ethyl lactate) in the layer of the material for the formation of the cores was calculated from a mass change before and after the heating (a decrease in weight resulting from the volatilization of the solvent). Heating conditions for the heating treatment were established so that the residual solvent concentration in the layer of the material for the formation of the cores after the heating was 1 wt % or less.

Then, using an i-bandpass filter, the layer of the material for the formation of the cores was exposed to 365-nm irradiation at a dose of 3000 mJ/cm² directed from over a chrome mask (photomask M) made of synthetic quartz and having openings corresponding to a straight core pattern by a proximity exposure method (with a gap of 125 μm) <using an exposure machine (MA-60F available from Mikasa Co., Ltd.) and an ultra-high-pressure mercury-vapor lamp (USH-250D available from Ushio Inc.)>. Thereafter, a heating treatment for hardening was performed at 100° C. for 10 minutes.

Next, dip development was performed for four minutes using γ-butyrolactone <available from Mitsubishi Chemical Corporation> to dissolve away unexposed portions of the layer of the material for the formation of the cores. Thereafter, a heating treatment for drying was performed at 100° C. for five minutes to produce the plurality of cores. A sectional dimension of the resultant layer of cores was 50 μm in height (thickness) when measured under a digital microscope <VHX-200 available from Keyence Corporation>.

Subsequently, the material for the formation of the cladding layers was applied onto the resultant cores and the under cladding layer with a spin coater <1X-DX2 available from Mikasa Co., Ltd.>. Thereafter, ultraviolet light (mixed irradiation) was directed toward the entire surface of the applied material to expose the entire surface to the ultraviolet light at a dose of 1000 mJ/cm²<using an exposure machine (MA-60F available from Mikasa Co., Ltd.) and an ultra-high-pressure mercury-vapor lamp (USH-250D available from Ushio Inc.)>. Subsequently, a heating treatment for hardening was performed at 80° C. for five minutes to produce the over cladding layer. This provided a polymer optical waveguide. A sectional dimension of the over cladding layer was 75 μm in thickness when measured under a digital microscope <VHX-200 available from Keyence Corporation>.

### Comparative Example 1

In the process of producing the cores, a heating treatment (with reference to FIG. 2B) was performed at 60° C. for 30 minutes after the application of the material for the formation of the cores, so that the residual solvent concentration in the layer of the material for the formation of the cores after the heating was approximately 1.5 wt %. Except for this difference, a polymer optical waveguide in Comparative Example 1 was manufactured in a manner similar to that in the Inventive Example. The thicknesses of the respective layers (the under cladding layer, the cores, and the over cladding layer) in the manufactured polymer optical waveguide in Comparative Example 1 were equal to those in the Inventive Example.

### Comparative Example 2

In the process of producing the cores, a heating treatment (with reference to FIG. 2B) was performed at 60° C. for five minutes after the application of the material for the formation of the cores, so that the residual solvent concentration in the layer of the material for the formation of the cores after the heating was approximately 4.5 wt %. Except for this difference, a polymer optical waveguide in Comparative Example 2 was manufactured in a manner similar to that in the Inventive Example. The thicknesses of the respective layers (the under cladding layer, the cores, and the over cladding layer) in the manufactured polymer optical waveguide in Comparative Example 2 were equal to those in the Inventive Example.

### Comparative Example 3

In the process of producing the cores, a heating treatment (with reference to FIG. 2B) was performed at 60° C. for one minute after the application of the material for the formation of the cores, so that the residual solvent concentration in the layer of the material for the formation of the cores after the heating was approximately 8.5 wt %. Except for this difference, a polymer optical waveguide in Comparative Example 3 was manufactured in a manner similar to that in the Inventive Example. The thicknesses of the respective layers (the under cladding layer, the cores, and the over cladding layer) in the manufactured polymer optical waveguide in Comparative Example 3 were equal to those in the Inventive Example.

### Relationship Between Residual Solvent Concentration and Core Width

A relationship between the residual solvent concentration (wt %) in the layer of the material for the formation of the cores prior to the exposure to ultraviolet light and the width of the produced cores, and a relationship between the residual solvent concentration (wt %) in the layer of the material for the formation of the cores prior to the exposure to ultraviolet light and the total loss of the ultraviolet light were investigated for the polymer optical waveguides in the Inventive Example and Comparative Examples 1 to 3. Also, the ultraviolet light guided through the cores was visually observed by NFP image observation.

Each of the manufactured polymer optical waveguides was cut vertically along the width thereof, and the cross-section thereof was observed with a digital microscope (VHX-200) available from Keyence Corporation. Thus, the width of the cores (the whole width of the cores along the width of each polymer optical waveguide) was measured. All of the cores had a height of 50 μm.

In the Inventive Example (n=6), all of the values of the residual solvent concentration in the layer of the material for the formation of the cores prior to the exposure to ultraviolet light were less than 1 wt %, and the whole width of the produced cores was 44 to 50 μm (an average of 48.1 μm).

In Comparative Example 1 (n=1), the residual solvent concentration in the layer of the material for the formation of the cores prior to the exposure to ultraviolet light was approximately 1.5 wt %, and the whole width of the produced cores was 59 μm.

In Comparative Example 2 (n=2), the residual solvent concentration in the layer of the material for the formation of the cores prior to the exposure to ultraviolet light was approximately 4.5 wt %, and the whole width of the produced cores was 67.9 μm.

In Comparative Example 3 (n=1), the residual solvent concentration in the layer of the material for the formation of the cores prior to the exposure to ultraviolet light was approximately 8.5 wt %, and the whole width of the produced cores was 74 μm.

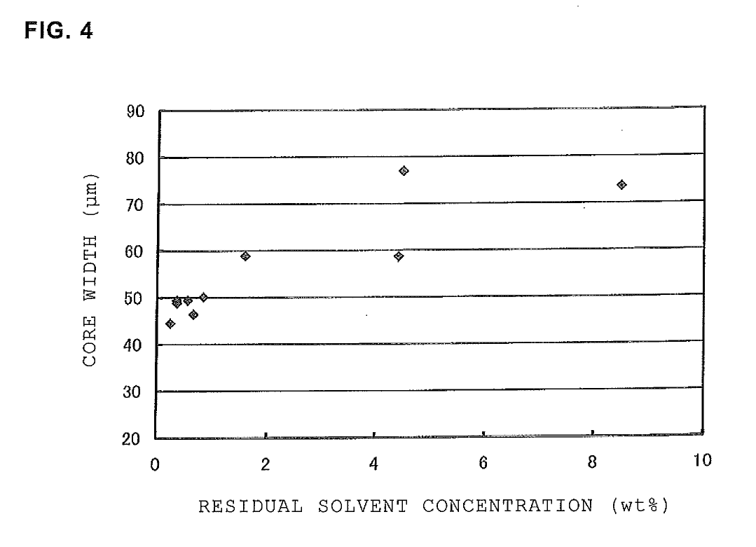

FIG. 4 is a graph showing plots of the above-mentioned results, on which the ordinate represents the above-mentioned measured width of the cores in μm and the abscissa represents the above-mentioned residual solvent concentration in the layer of the material for the formation of the cores prior to the exposure to ultraviolet light in wt %.

### Relationship Between Residual Solvent Concentration and Light Propagation Loss in Cores

Next, the total loss in the produced cores was measured by a method compliant with JIS (Japanese Industrial Standards) C 6823.

In the Inventive Example (n=6), all of the values of the residual solvent concentration in the layer of the material for the formation of the cores prior to the exposure to ultraviolet light were less than 1 wt %, and the total loss in the produced cores was 1.6 to 2.1 dB per 10 cm (an average of 1.8 dB per 10 cm).

In Comparative Example 1 (n=1), the residual solvent concentration in the layer of the material for the formation of the cores prior to the exposure to ultraviolet light was approximately 1.5 wt %, and the total loss in the produced cores was 4.3 dB per 10 cm.

In Comparative Example 2 (n=2), the residual solvent concentration in the layer of the material for the formation of the cores prior to the exposure to ultraviolet light was approximately 4.5 wt %, and the total loss in the produced cores was 5.4 dB per 10 cm.

In Comparative Example 3 (n=1), the residual solvent concentration in the layer of the material for the formation of the cores prior to the exposure to ultraviolet light was approximately 8.5 wt %, and the total loss in the produced cores was 5.1 dB per 10 cm.

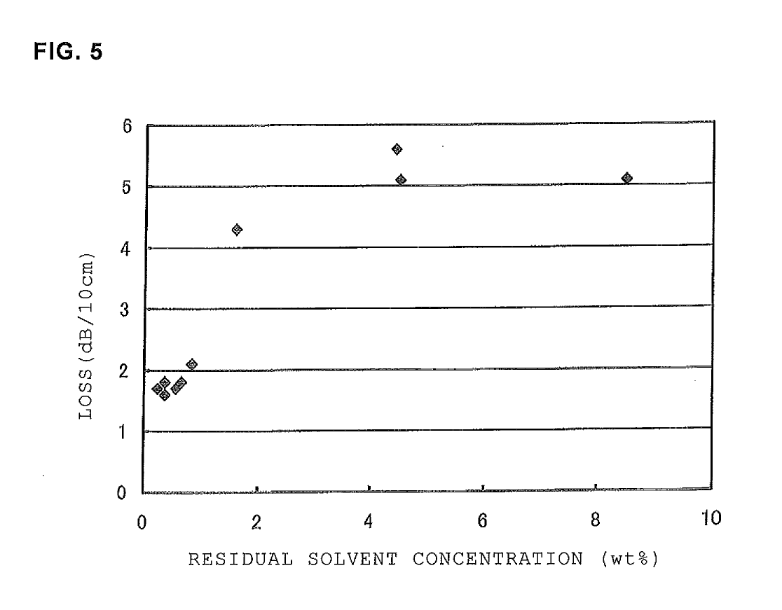

FIG. 5 is a graph showing plots of the above-mentioned results, on which the ordinate represents the measured value of the total loss in the cores in dB per 10 cm and the abscissa represents the above-mentioned residual solvent concentration in the layer of the material for the formation of the cores prior to the exposure to ultraviolet light in wt %.

The foregoing results show that, in the photo-cationic polymerizable resin composition serving as the material for the formation of the cores and containing O-cresol novolac glycidyl ether used as the photo-cationic polymerizable epoxy resin, a 50% propione carbonate solution of a triaryl sulfonium salt used as the photo-acid generator, and ethyl lactate used as the solvent therefor, the residual solvent concentration in the material for the formation of the cores prior to the irradiation with ultraviolet light which is adjusted to 1 wt % or less by the previous heating treatment improves the dimensional accuracy of the width of the cores to consequently achieve the provision of a high-quality polymer optical waveguide with low loss of light in the cores.

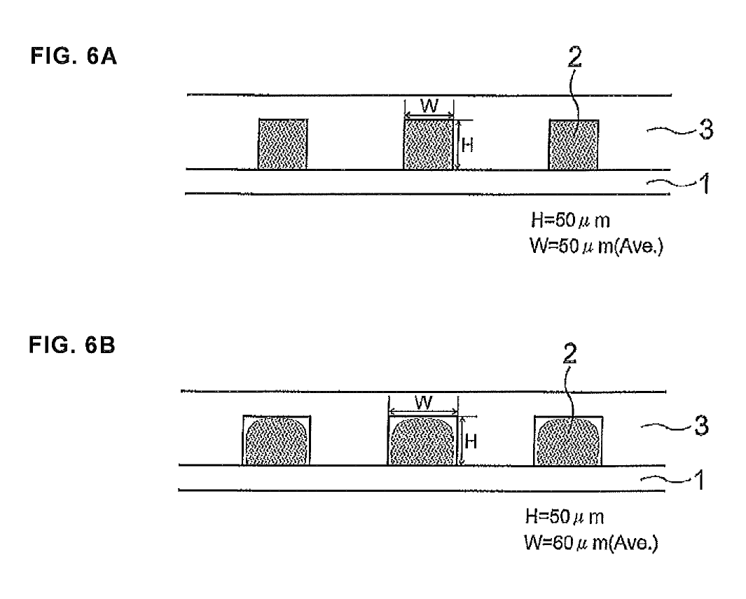

Also, the results of the observation of the ultraviolet light guided through the cores of the polymer optical waveguides in the Inventive Example and Comparative Example 1 by NFP image observation showed that the cores of the polymer optical waveguide in the Inventive Example were very sharply outlined, as shown schematically in FIG. 6A, which in turn indicated that the light was guided evenly through the cores. On the other hand, it was found that the cores of the polymer optical waveguide which were expanded laterally (widthwise) than designed had broad outlines, as shown schematically in FIG. 6B, which in turn indicated that the light was guided unevenly through the cores.

The method of manufacturing a polymer optical waveguide is widely applicable to the manufacture of polymer optical waveguides for use in the fields of optical communications, optical information processing and other general optics.

Although a specific form of embodiment of the instant invention has been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

What is claimed is:

1. A method of manufacturing a polymer optical waveguide, comprising the steps of:
(a) forming an under cladding layer on a substrate;
(b) forming light-transmitting cores on the under cladding layer; and
(c) forming an over cladding layer so as to cover the cores,
said step (b) including the substeps of
(b-1) applying a core-forming resin composition to the surface of the under cladding layer, the core-forming resin composition containing a photosensitive resin of the type hardenable by a photo-cationic polymerization reaction, and a solvent,
(b-2) heating the core-forming resin composition to volatilize the solvent in the core-forming resin composition,
(b-3) controlling heating conditions in the substep (b-2) to adjust a residual solvent concentration in the core-forming resin composition to 1 wt % or less, and
(b-4) directing irradiation light through a photomask toward a layer of the core-forming resin composition after the substep (b-2) to expose the layer of the core-forming resin composition to the irradiation light, and then developing the layer of the core-forming resin composition to form the cores of a predetermined pattern.
